(19) United States
(12) Patent Application Publication
(10) Pub. No.: US 2025/0175660 A1
(43) Pub. Date: May 29, 2025

(54) RECOMMENDATION SYSTEM COMPRISING ELECTRONIC DEVICE AND SERVER, AND METHOD FOR OPERATING RECOMMENDATION SYSTEM

(71) Applicant: SAMSUNG ELECTRONICS CO., LTD., Suwon-si (KR)

(72) Inventors: Hwangki MIN, Suwon-si (KR); Yoonyoung NAM, Suwon-si (KR); Junyeop LEE, Suwon-si (KR)

(73) Assignee: SAMSUNG ELECTRONICS CO., LTD., Suwon-si (KR)

(21) Appl. No.: 19/037,933

(22) Filed: Jan. 27, 2025

Related U.S. Application Data
(63) Continuation of application No. PCT/KR2023/007788, filed on Jun. 7, 2023.

(30) Foreign Application Priority Data
Jul. 27, 2022 (KR) 10-2022-0093132

(51) Int. Cl. H04N 21/25; G06Q 30/0601

(52) U.S. Cl. CPC H04N 21/252; G06Q 30/0631

(57) ABSTRACT

Disclosed is a recommendation system including a server that includes a recommendation model pre-trained based on past item histories of multiple users; and a user-item matrix predicted by the recommendation model. The server extracts, based on receiving a recommendation request, a first submatrix for approximating the recommendation model to a dedicated recommendation model for a target user from the predicted user-item matrix and transmit the first submatrix. The recommendation system includes an electronic device that provides the target user with a recommended item using the dedicated recommendation model trained based on a second submatrix generated by reprocessing the first submatrix based on an item history of the target user at a time of transmitting the recommendation request.

### CROSS-REFERENCE TO RELATED APPLICATIONS

This application is a bypass continuation application of International Application No. PCT/KR2023/007788 designating the United States, filed on Jun. 7, 2023, in the Korean Intellectual Property Receiving Office and claiming priority to Korean Patent Application No. 10-2022-0093132, filed on Jul. 27, 2022, in the Korean Intellectual Property Office, the disclosures of which are incorporated by reference herein in their entireties.

### BACKGROUND

### 1. Field

The disclosure relates to a recommendation system including an electronic device and a server, and a method of operating the recommendation system.

### 2. Description of Related Art

With the development of information and communications technology and the popularization of the Internet, the means to receive information is growing to various media such as personal computers, various mobile devices such as smartphones and tablet PCs, as well as car navigation systems and/or smart TVs. The growth in such information providing media has also led to an explosive increase in information production. The types of content provided through various information providing media may be very diverse and vast, such as, for example, image content, music content, video content, game content, and real-time information content. It may be practically impossible for every user to accept such diverse and vast content.

### SUMMARY

According to an aspect of the disclosure, there is provided a recommendation system including: a server including: a recommendation model pre-trained based on past item histories of multiple users; and a user-item matrix predicted by the recommendation model, wherein the server is configured to, based on receiving a recommendation request, extract a first submatrix for approximating the recommendation model to a dedicated recommendation model for a target user from the predicted user-item matrix and transmit the first submatrix; and an electronic device configured to: transmit the recommendation request; and provide the target user with a recommended item using the dedicated recommendation model trained based on a second submatrix generated by reprocessing the first submatrix based on an item history of the target user at a time of transmitting the recommendation request.

The server may include a memory configured to store the recommendation model and the predicted user-item matrix representing a degree of interactions between the multiple users and multiple items predicted by the recommendation model; a processor configured to extract the first submatrix from the predicted user-item matrix; and a communication interface configured to receive the recommendation request and transmit the first submatrix to the electronic device.

The processor may be configured to: identify first similar users similar to the target user corresponding to the electronic device among the multiple users; identify candidate items to be provided to the target user among the multiple items; and extract the first submatrix corresponding to the first similar users and the candidate items from the predicted user-item matrix.

The processor may be configured to identify the first similar users based on at least one of additional information of the target user or a past item history of the target user, wherein the additional information of the target user may include one or more of a gender, an age, an occupation, a residence, or an interest of a user.

The processor may be configured to identify the first similar users based on a result of comparing similarities between items included in the predicted user-item matrix and items included in the past item history of the target user.

The processor may be configured to identify the first similar users based on a result of comparing similarities between users included in the predicted user-item matrix and the additional information of the target user.

The processor may be configured to identify the candidate items based on past item histories of the first similar users, recommended items predicted for the first similar users by the recommendation model, and items selected from among the multiple items other than the recommended item.

The electronic device may include: a communication interface configured to transmit the recommendation request to the server and receive the first submatrix from the server in response to the recommendation request; a processor configured to extract second similar users from the first submatrix based on an item history of the target user at the time of transmitting the recommendation request, extract the second submatrix corresponding to the second similar users from the first submatrix, and provide the target user with a recommended item using the dedicated recommendation model trained based on the second submatrix; and a memory configured to store the dedicated recommendation model.

According to an aspect of the disclosure, there is provided an electronic device including: a communication interface configured to transmit a recommendation request to a server and receive a first submatrix for approximating a recommendation model stored in the server to a dedicated recommendation model for a target user of the electronic device from the server in response to the recommendation request; a processor configured to generate a second submatrix corresponding to second similar users extracted from the first submatrix based on an item history of the target user at a time of transmitting the recommendation request, and provide the target user with a recommended item using the dedicated recommendation model trained based on the second submatrix; and a memory configured to store the trained dedicated recommendation model.

The processor may be configured to extract the second similar users from among first similar users based on similarities between the item history of the target user at the time of transmitting the recommendation request and candidate items included in the first submatrix.

The processor may be configured to extract the second submatrix corresponding to the second similar users from the first submatrix.

The processor may be configured to provide the target user with a recommended item corresponding to the time of transmitting the recommendation request and an explanation corresponding to recommended items using the trained dedicated recommendation model.

The dedicated recommendation model may be trained by a machine learning technique based on the second submatrix.

According to an aspect of the disclosure, there is provided a method of operating a recommendation system including a server and an electronic device, the method including: transmitting, by the electronic device, a recommendation request to the server including a recommendation model pre-trained based on past item histories of multiple users and a user-item matrix predicted by the recommendation model; extracting, by the server, a first submatrix for approximating the recommendation model to a dedicated recommendation model for a target user from the predicted user-item matrix in response to the recommendation request; transmitting, by the server, the first submatrix to the electronic device; generating, by the electronic device, a second submatrix corresponding to second similar users extracted from the first submatrix based on an item history of the target user at a time of transmitting the recommendation request; and providing, by the electronic device, a recommended item to the target user using the dedicated recommendation model trained based on the second submatrix.

The extracting of the first submatrix may include: identifying first similar users similar to the target user among the multiple users; identifying candidate items to be provided to the target user among multiple items; and extracting the first submatrix corresponding to the first similar users and the candidate items from the predicted user-item matrix, wherein the identifying of the first similar users may include identifying the first similar users based on at least one of additional information of the target user or a past item history of the target user, wherein the additional information may include one or more of a gender, an age, or an interest of a user.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 is a diagram illustrating a configuration of a recommendation system according to an embodiment;

FIG. 2 is a diagram illustrating an operation of a recommendation model according to an embodiment;

FIG. 3 is a diagram illustrating a process of approximating a recommendation model to a dedicated recommendation model according to an embodiment;

FIG. 4 is a block diagram of a server according to an embodiment;

FIG. 5 is a diagram illustrating an operation of a server according to an embodiment;

FIG. 6 is a block diagram of an electronic device according to an embodiment;

FIG. 7 is a diagram illustrating an operation of an electronic device according to an embodiment;

FIG. 8 is a diagram illustrating an explainable recommendation model according to an embodiment;

FIG. 9 is a flowchart illustrating a method of operating a recommendation system according to an embodiment;

FIG. 10 is a flowchart illustrating a method of extracting a first submatrix according to an embodiment;

FIG. 11 is a flowchart illustrating a method of extracting a second submatrix according to an embodiment; and

FIG. 12 is a block diagram of an electronic device in a network environment according to an embodiment.

### DETAILED DESCRIPTION

Below, embodiments will be described in detail with reference to the accompanying drawings. When describing the embodiments with reference to the accompanying drawings, like reference numerals refer to like components, and any repeated description related thereto will be omitted.

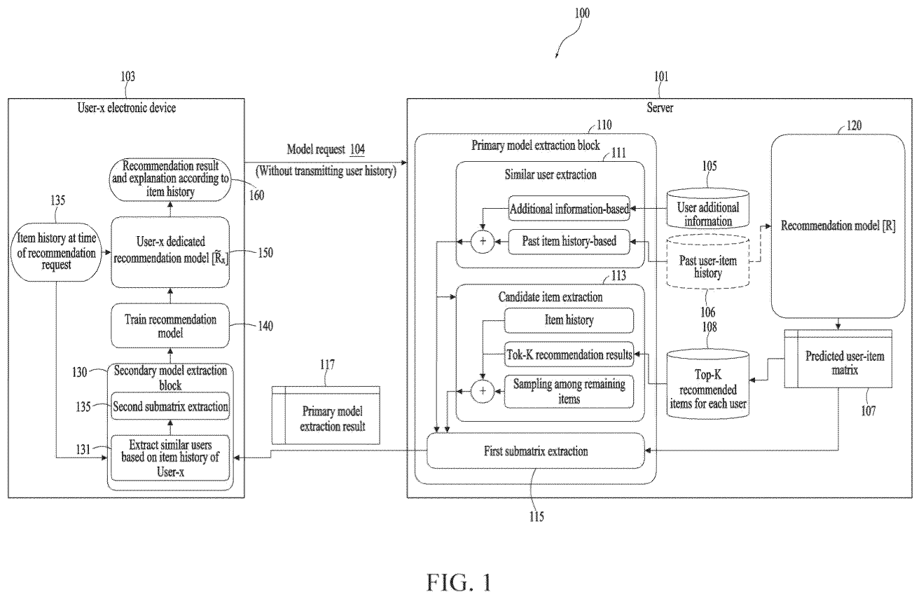

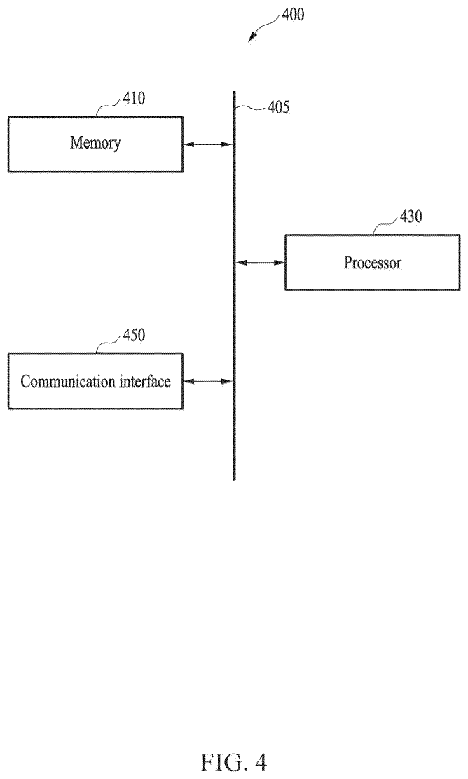

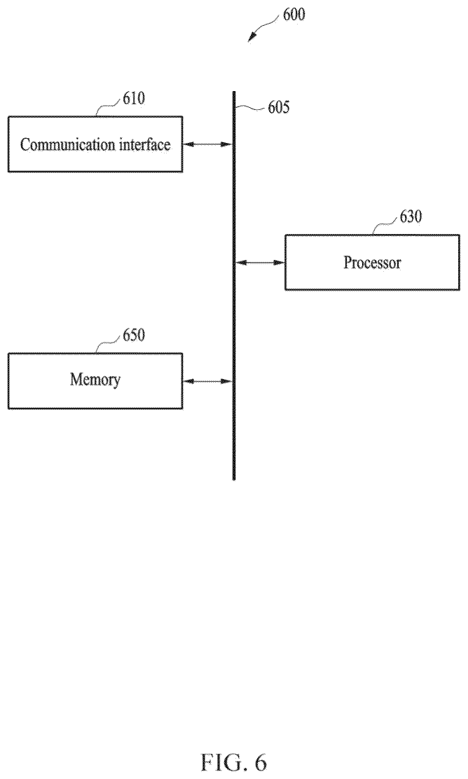

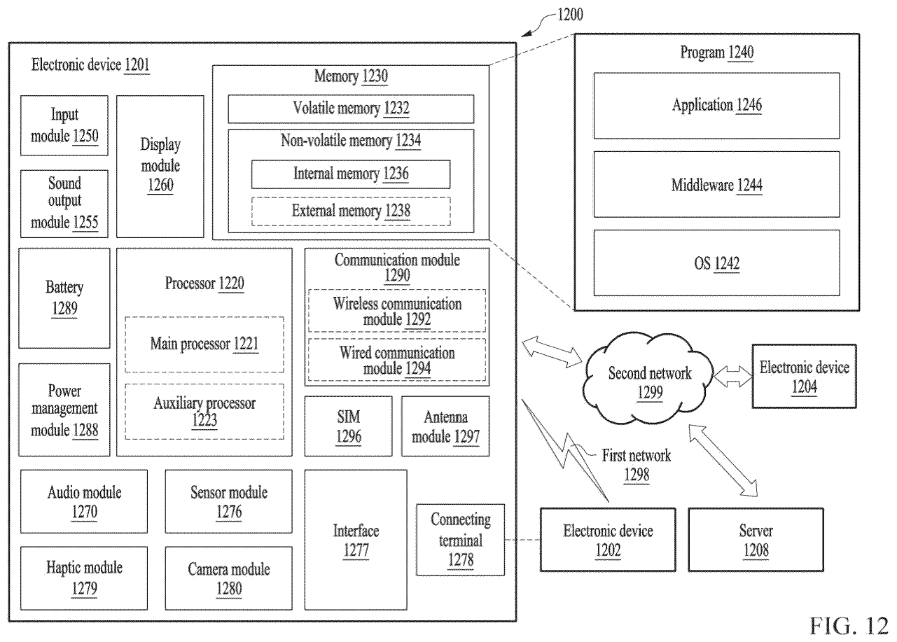

FIG. 1 is a diagram illustrating a configuration of a recommendation system according to an embodiment. Referring to FIG. 1, a configuration diagram of a recommendation system 100 including a server 101 (e.g., a server 400 of FIG. 4 and/or a server 1208 of FIG. 12) and an electronic device 103 (e.g., an electronic device 600 of FIG. 6 and/or an electronic device 1201 of FIG. 12) of User x according to an embodiment is illustrated.

The recommendation system 100 may automatically recommend items to the user. Here, the “items” may include, but are not necessarily limited to, various multimedia contents such as news, movies, music, and apps, and/or applications in which multimedia contents can be searched, used, and/or purchased.

Additionally, the recommendation system 100 may provide a recommended item corresponding to a recommendation result and an explanation with which the user (e.g., User x) may understand the recommendation result.

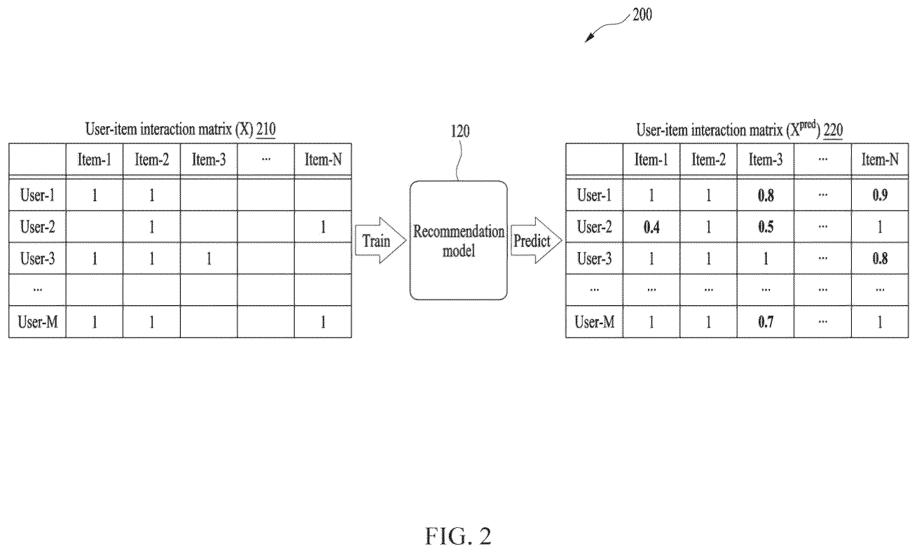

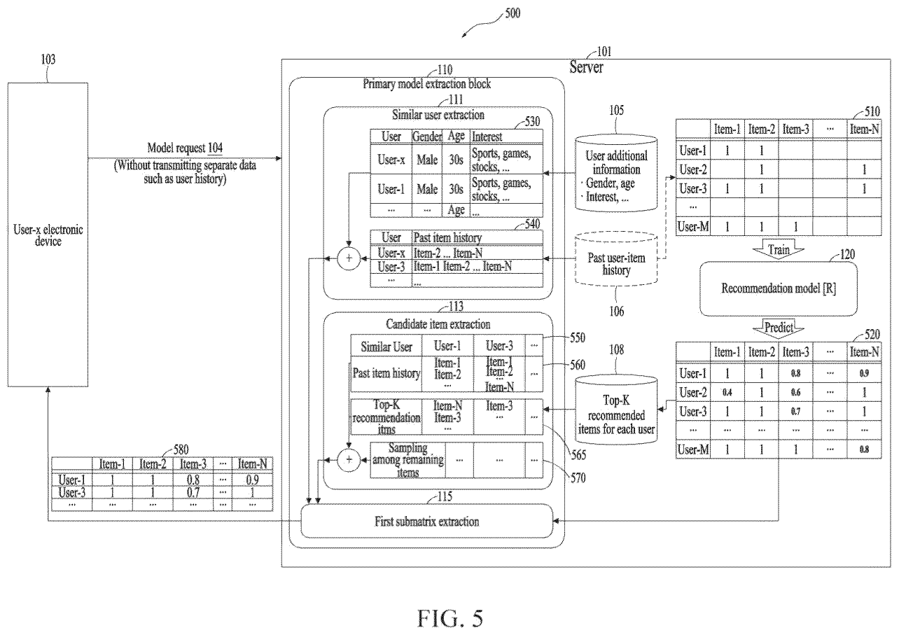

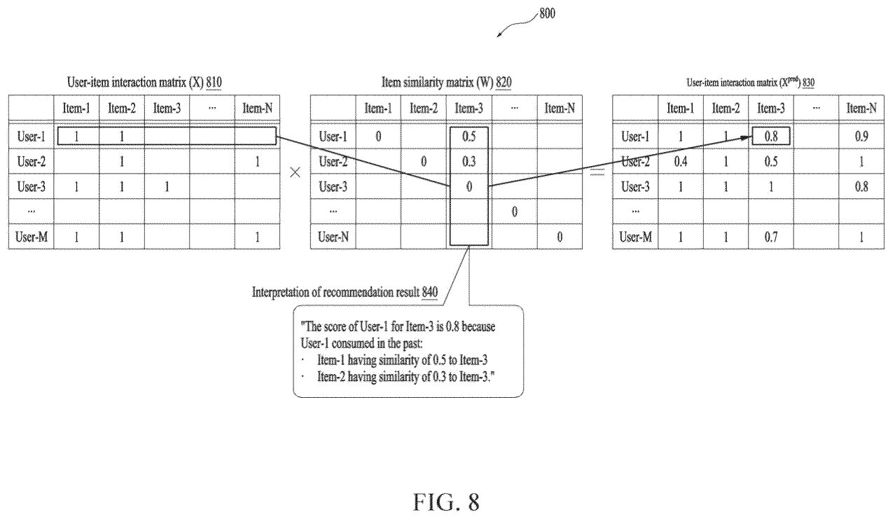

The server 101 may include a recommendation model (R) 120 pre-trained based on past item histories of multiple users and a user-item matrix 107 predicted by the recommendation model (R) 120 (e.g., a predicted user-item matrix 220 of FIG. 2, a predicted user-item matrix 520 of FIG. 5, and/or a predicted user-item matrix 830 of FIG. 8). The recommendation model (R) 120 may be a machine learning-based recommendation model that is trained by collecting past item history data from multiple users. The recommendation model (R) 120 may be a complex model that consumes a lot of storage resources and processing resources. The recommendation model (R) 120 may predict the user-item matrix 107 representing the degree of interactions between multiple users and multiple items. The recommendation model (R) 120 may generate an M×N user-item matrix by predicting the degree of interactions for, for example, M users (User-1, User-2, . . . , User-M) and N items (Item-1, Item-2, . . . , Item-N). The recommendation model (R) 120 is described in more detail with reference to FIG. 2 below.

The server 101 may receive a model request 104 transmitted from the electronic device 103 of User x. User x is a user who has requested a recommendation of content from the server 101, and may be called a “target user” in that User x is the target of the recommendation of content. The model request 104 may be a request for a model to be used for content recommendation for User x. The model request 104 may also be called a “recommendation request” in that it is a request for content recommendation. Hereinafter, the “model request” and the “recommendation request” may be used interchangeably.

The recommendation request 104 may only specify information about who requested a recommendation (e.g., identification information of User x) and may not include any personal information of the user, such as specific item history, thereby preventing personal information from leaking.

In response to receiving the recommendation request 104, the server 101 may extract a first submatrix 117 (e.g., a first submatrix 580 of FIG. 5) for approximating the recommendation model (R) 120 to a dedicated recommendation model (\tilde{R}ₓ) 150 for the target user (e.g., User x), from the user-item matrix 107 predicted by the recommendation model (R) 120.

The server 101 may extract information (e.g., the first submatrix 117) to be used by the electronic device 103 to construct the dedicated recommendation model (\tilde{R}ₓ) 150 from the recommendation model (R) 120 through a primary model extraction block 110 and transmit the information to the electronic device 103. The dedicated recommendation model (\tilde{R}ₓ) 150 may be an interpretable recommendation model dedicated to User x.

The primary model extraction block 110 may include, for example, a similar user extraction module 111, a candidate item extraction module 113, and a first submatrix extraction module 115, but is not necessarily limited thereto.

The similar user extraction module 111 may estimate, for example, M₁(M₁<<M) similar users who are similar to User x who transmitted the recommendation request 104 among the M users included in the user-item matrix 107 predicted by the recommendation model (R) 120. The similar user extraction module 111 may extract the similar users using user additional information 105 already in the server 101. The user additional information 105 may include, but is not necessarily limited to, various pieces of information (e.g., the gender, age, occupation, hobbies, and interests of User x) other than information related to items purchased by the user.

For example, a past user-item history 106 of User x who requested a recommendation may remain in the server 101. The past user-item history 106 of User x may be the history of items that the target user, User x, purchased (downloaded) in the past and/or used in the past. The past user-item history 106 may be unrelated to the item history of User x at the time of transmitting the recommendation request 104. In this case, the similar user extraction module 111 may additionally select similar users by comparing the past user-item history 106 of User x with the item histories of similar users recommended by the recommendation model (R) 120. The operation of selecting similar users using the past user-item history 106 of User x by the similar user extraction module 111 may be optionally performed when the past user-item history 106 of User x is in the server 101.

The candidate item extraction module 113 may select N₁(N₁<<N) candidate items to be provided to User x who requested a recommendation among the N users included in the user-item matrix 107 predicted by the recommendation model (R) 120. The candidate item extraction module 113 may select, for example, as candidate items, items selected at random from past item histories of M₁ similar users extracted by the similar user extraction module 111, top-K recommended items 108 predicted by the recommendation model (R) 120 for the M₁ similar users, and the remaining items excluding the top-K recommended items 108 from the multiple items. At this time, the top-K recommended items 108 predicted by the recommendation model (R) 120 for the M₁ similar users may be determined based on the user-item matrix 107 predicted by the recommendation model (R) 120. The remaining items excluding the top-K recommended items 108 may be, for example, a portion of the items corresponding to lower rankings based on recommendation scores.

In training a neural network-based model, the performance may be better when negative items that a user is not interested in are provided together, compared to when only positive items, such as items that the user is interested in, are provided. In an embodiment, adding the items selected at random from the multiple items to the candidate items as training data for generating a model for predicting the interest of User x in items may improve the recommendation performance of the dedicated recommendation model (\tilde{R}ₓ) 150. Additionally, the dedicated recommendation model (\tilde{R}ₓ) 150 generated from the electronic device 103 of User x may basically operate only for items included in data to be provided to the server 101. In an embodiment, the coverage of items may be expanded by adding the items selected at random from the multiple items to the candidate items to include as many items as possible in training the dedicated recommendation model (\tilde{R}ₓ) 150. For example, when a cost is limited, the candidate item extraction module 113 may select candidate items more from positive items and fewer from negative items, thereby improving efficiency.

The first submatrix extraction module 115 may extract the first submatrix 117 for the similar users selected by the similar user extraction module 111 and the recommended items extracted by the candidate item extraction module 113 from the M×N user-item matrix predicted by the recommendation model (R) 120. The first submatrix extraction module 115 may transmit the extracted first submatrix 117 to the electronic device 103. At this time, the first submatrix 117 may have the form of, for example, an M₁×N₁ (here, M₁<<M, N₁<<N) user-item matrix. The first submatrix 117 may be information to approximate the recommendation model (R) 120 to an interpretable recommendation model 150 dedicated to User x.

The electronic device 103 may transmit the recommendation request (or model request) 104 to the server 101. At this time, the recommendation request 104 may not include the item history of the user. The electronic device 103 may train, in operation 140, the dedicated recommendation model (\tilde{R}ₓ) 150 based on a second submatrix extraction module 135 generated by reprocessing the first submatrix 117, based on an item history 135 of the target user (User x) at the time of transmitting the recommendation request 104.

The electronic device 103 may generate a second submatrix by reprocessing the first submatrix 117 transmitted from the server 101 by a secondary model extraction block 130 in response to the recommendation request 104.

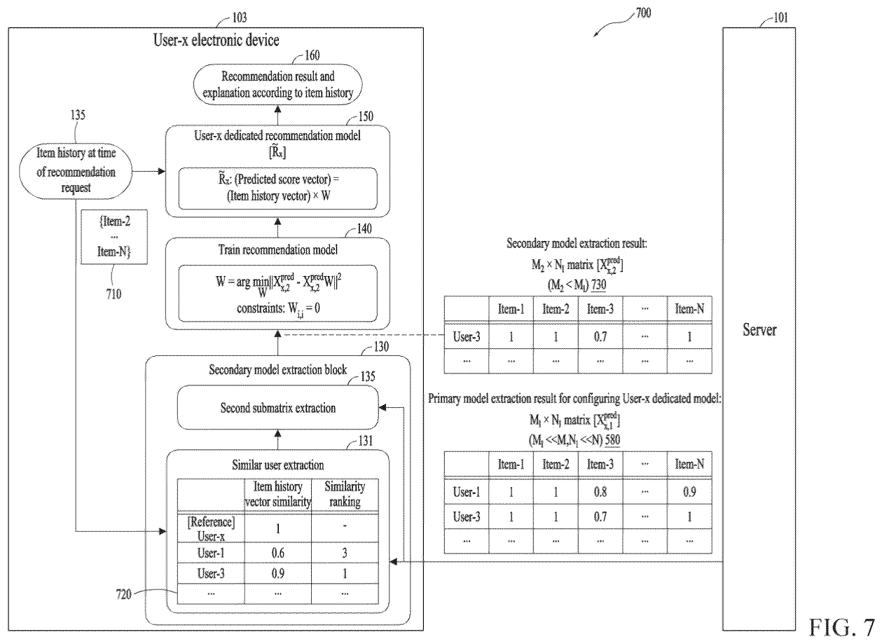

The secondary model extraction block 130 may extract second similar users from the first submatrix 117 based on the specific item history information 135 at the current time of the user, that is, the time of the recommendation request 104, and extract the second submatrix (e.g., a second submatrix 730 of FIG. 7) corresponding to the second similar users. The secondary model extraction block 130 may include, for example, a similar user extraction module 131 and the second submatrix extraction module 135.

The similar user extraction module 131 may extract, for example, M₂(M₂<M₁) second similar users from the first submatrix 117 based on the item history 135 of User x at the time of transmitting the recommendation request 104. The similar user extraction module 131 may extract the second similar users from among first similar users based on similarities between the item history 135 of User x at the time of transmitting the recommendation request 104 and the candidate items included in the first submatrix 117. The similar user extraction module 131 may extract the second similar users by comparing the similarity between items through various methods of calculating vector similarity.

The similar user extraction module 131 may compare, for example, the similarities between the vector of the item history 135 at the current time of User x, that is, the time of transmitting the recommendation request 104 and user-specific item vectors in the first submatrix 117 received from the server 101. The similar user extraction module 131 may compare the similarities between the vector of the item history 135 at the time of transmitting the recommendation request 104 and the user-specific item vectors in the first submatrix 117 using vector similarity calculation methods.

The vector similarity calculation methods may include, for example, angle-based cosine similarity, Jaccard similarity, and/or distance-based Euclidean distance, but are not necessarily limited thereto. “Cosine similarity” may refer to the similarity between two vectors that can be obtained using the cosine angle between the two vectors. For example, if the directions of the two vectors are completely identical, the cosine similarity may have a value of “1”. If the two vectors form an angle of 90 degrees, the cosine similarity may have a value of “0”. Or, if the directions of the two vectors are completely opposite at 180 degrees, the cosine similarity may have a value of “−1”. For example, the cosine similarity may have a value greater than or equal to “−1” and less than or equal to “1”, and may indicate a higher similarity if closer to “1” and a lower similarity if closer to “−1”. Intuitively understanding, the cosine similarity may indicate how similar the directions of the two vectors are. “Jaccard similarity” may convert vectors into binary data “0” and “1” and then obtain the similarity based on the ratio of the intersection and union of the two vectors (intersection/union). Jaccard similarity may have a value between “0” and “1”, and may have a value of “1” if the two sets are identical and a value of “0” if the two sets do not have any common element. “Euclidean distance” may be the distance between a vector p and a vector q corresponding to two points in multi-dimensional space. A shorter Euclidean distance may indicate that the similarity is higher, while a longer Euclidean distance may indicate that the similarity is lower.

The similar user extraction module 131 may determine similarity rankings of the first similar users (e.g., identify first similar users) based on the result of comparing the similarity between the item vectors. Here, the “similarity rankings” may be sequential rankings indicating the similarities of the first similar users to User x based on the similarity between the item vectors. The “similarity rankings” may also be called “similarity scores”.

The similar user extraction module 131 may determine some of the first similar users included in the first submatrix 117 to be the second similar users close to User x, in the order of high similarity rankings.

The second submatrix extraction module 135 may extract the second submatrix 730 corresponding to the second similar users from the first submatrix 117. For example, if the first submatrix 117 is an M₁×N₁ matrix, the second submatrix 730 may be an M₂×N₁ matrix. At this time, M₂<M₁ may be satisfied.

The electronic device 103 may generate the dedicated recommendation model (\tilde{R}ₓ) 150 for User x through training, in operation 140, by the second submatrix 730 extracted by the secondary model extraction block 130. In other words, the electronic device 103 may train, in operation 140, the dedicated recommendation model (\tilde{R}ₓ) 150 based on the second submatrix 730. The dedicated recommendation model (\tilde{R}ₓ) 150 may be one obtained by approximating the complex recommendation model (R) 120 for multiple users on the server 101 to a model adjacent to the item history at the current time of User x, that is, a simple and interpretable model that is valid only for User x. At this time, the form of the dedicated recommendation model (\tilde{R}ₓ) 150 may be pre-specified.

The dedicated recommendation model (\tilde{R}ₓ) 150 may be trained based on the second submatrix 730. The dedicated recommendation model (\tilde{R}ₓ) 150 may be trained, in operation 140, to output recommended items for User x along with an explanation of the reason for recommending the recommended items, when the item history information of User x at the current time (the time of the recommendation request 104) is input.

The electronic device 103 may provide recommended items and explanation 160 corresponding to the recommendation result to the target user using the trained dedicated recommendation model (\tilde{R}ₓ) 150. The recommended items and explanation 160 corresponding to the recommendation result by the dedicated recommendation model (\tilde{R}ₓ) 150 may be provided in the form of such as, for example, an interpretation 840 of the recommendation result of FIG. 8 below, but is not limited thereto.

FIG. 2 is a diagram illustrating an operation of a recommendation model according to an embodiment. Referring to FIG. 2, a diagram 200 shows an example of training the recommendation model (R) 120 based on a user-item interaction matrix (X) 210 and outputting a user-item interaction matrix (X^{pred}) 220 obtained by the trained recommendation model (R) 120 predicting the empty value(s) of elements in the user-item interaction matrix (X) 210 according to an embodiment. For ease of description below, the “user-item interaction matrix” is simply referred to as the “user-item matrix”.

The user-item matrix (X) 210 may represent the past history of multiple items that had interactions with multiple users in the form of a matrix. Here, an “interaction” may include, for example, a predetermined action performed between a user and an item such as purchasing (downloading), storing, recommending, and/or consuming (using) the item, and/or all processes and methods in which the user and the item form a relationship. For example, if there are M user(s) and N item(s), the user-item matrix (X) 210 may have the form of an M×N matrix. At this time, if there was an interaction between the user and the item in the M×N user-item matrix (X) 210, the value(s) of corresponding elements of the user-item matrix (X) 210 may be “1”. Conversely, if there was no interaction between the user and the item, the value(s) of the corresponding elements of the user-item matrix (X) 210 may be “0” or empty.

In most recommendation problems, the number of users M and the number of items N may be large, while the number of items that had interactions with the users may not be that large. In this case, the user-item matrix (X) 210 may have the form of a sparse matrix with relatively many “0”s in the elements of the matrix.

The recommendation model (R) 120 may predict the values of elements empty (or marked as “0”) in the user-item matrix (X) 210. The user-item matrix (X^{pred}) 220 (e.g., the predicted user-item matrix 107 of FIG. 1, the predicted user-item matrix 520 of FIG. 5, and/or the predicted user-item matrix 830 of FIG. 8) may be a matrix in which the values of empty elements in the user-item matrix (X) 210 are filled with values predicted by the recommendation model (R) 120. The user-item matrix (X^{pred}) 220 in which the values of empty elements in the user-item matrix (X) 210 are filled with the values predicted by the recommendation model (R) 120 may be called the “predicted user-item matrix” to be distinguished from the user-item matrix (X) 210.

The recommendation model (R) 120 may predict the possibilities of interactions for items that had no interaction based on the history of items that had interactions with the user in the past, as in the user-item matrix (X^{pred}) 220. In an embodiment, the recommendation model (R) 120 may be trained using additional information of the target user already in the server 101 without specific item history of the user, thereby preventing personal information of the user related to the items from leaking.

The recommendation model (R) 120 may predict, for example, the possibilities of interactions between User-1 and Item-3 and Item-N that had no interaction with User-1 in the past, as 0.8 and 0.9, respectively. Additionally, the recommendation model (R) 120 may predict the possibilities of interactions between User-2 and Item-1 and Item-3 that had no interaction with User-2 in the past, as 0.4 and 0.5, respectively. The recommendation model (R) 120 may predict the possibilities of interactions for the items that had no interaction with users and fill, for example, all the values of the elements of the M×N user-item matrix (X^{pred}) 220.

According to an embodiment, the recommendation model (R) 120 may predict the possibilities of interactions for the items that had no interaction, further based on user additional information (e.g., the user additional information 105 of FIG. 1) and/or item additional information, in addition to the user-item matrix (X) 210.

The recommendation model (R) 120 may be a large and complex machine learning-based neural network model trained based on past item histories of multiple users to obtain excellent recommendation performance.

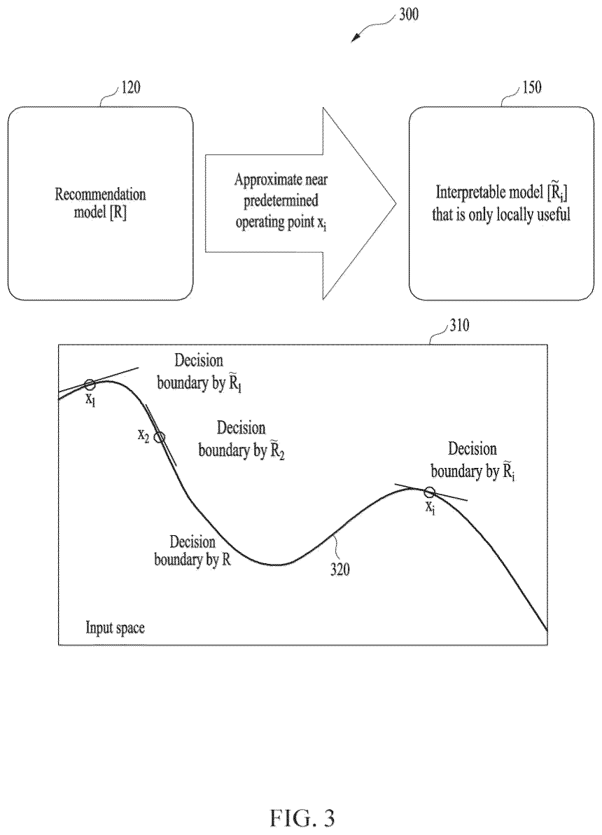

FIG. 3 is a diagram illustrating a process of approximating a recommendation model to a dedicated recommendation model according to an embodiment. Referring to FIG. 3, a diagram 300 conceptually shows the process of approximating the recommendation model (R) 120 to the dedicated recommendation model (\tilde{R}ᵢ) 150 for User x according to an embodiment.

A method of constructing a large and complex machine learning (ML) model in a server (e.g., the server 101 of FIG. 1, the server 400 of FIG. 4, and/or the server 1208 of FIG. 12) and then training the ML model using past item history data of a number of users collected by the server 101 may be useful to obtain excellent recommendation performance. However, if the electronic device 103 that uses limited resources operates the ML model trained by the server 101, an excessive cost may be incurred. In addition, if the electronic device 103 requests the server 101 to recommend content each time a recommendation is needed, user information may be transmitted to the server 101 to obtain a recommendation result, which may cause a risk that the personal information of the user leaks.

In an embodiment, by transmitting information to approximate the complex and large recommendation model (R) 120 to the dedicated recommendation model (\tilde{R}ᵢ) 150 for the target user to the electronic device 103 and generating the dedicated recommendation model (\tilde{R}ᵢ) 150 for the target user in the electronic device 103 based on the information, it is possible to maintain the recommendation performance of the recommendation model (R) 120 stored in the server 101 even in the electronic device 103 that uses limited resources.

According to an embodiment, an explanation of the recommendation result may be provided by approximating the recommendation model (R) 120 to the dedicated recommendation model (\tilde{R}ᵢ) 150 for User x for post hoc interpretation. The dedicated recommendation model (\tilde{R}ᵢ) 150 may provide a human-understandable explanation of the recommendation result of the dedicated recommendation model (\tilde{R}ᵢ) 150 together, through explainable AI (XAI) technology. Here, the explanation of the recommendation result may help a user trust the result and lead to actual actions, such as purchasing or consuming a recommended item.

In an embodiment, for example, an explanation of the recommendation result may be provided post hoc by a local model that approximates a recommendation result 320 by the recommendation model (R) 120 that appears non-linearly in an input space 310 to a predetermined operating point. The predetermined “operating point” may be any one point in the recommendation result 320 by the recommendation model (R) 120. Predetermined operating points may be, for example, x₁, x₂, and xᵢ. The predetermined operating points may correspond to, for example, users or items. Alternatively, the operating points may be the products between users and items. The number of operating points may be, for example, the number of users M or the number of items N. Additionally, the number of operating points may be, but is not necessarily limited to, the number of users M×the number of items N.

For example, a local model that approximates the recommendation result 320 by the recommendation model (R) 120 to the operating point x₁ may be a dedicated recommendation model (\tilde{R}₁) for User x₁. A local model that approximates the recommendation result 320 to the operating point x₂ may be a dedicated recommendation model (\tilde{R}₂) for User x₂. In addition, a local model that approximates the recommendation result 320 by the recommendation model (R) 120 to the operating point xᵢ may be a dedicated recommendation model (\tilde{R}ᵢ) 150 for User xᵢ. Here, “approximating the recommendation result 320 to the operating point xᵢ” may include points (e.g., xᵢ₋₁ and xᵢ₊₁) adjacent to the operating point xᵢ as well as the operating point xᵢ.

In an embodiment, an interpretable dedicated recommendation model (\tilde{R}ᵢ) 150 that is locally useful, in other words, that is for User xᵢ, may be constructed by approximating the recommendation result 320 by the recommendation model (R) 120 to a predetermined point xᵢ corresponding to the user, whereby the processing cost between the server 101 and the electronic device 103 may be distributed.

FIG. 4 is a block diagram of a server according to an embodiment. Referring to FIG. 4, a server 400 (e.g., the server 101 of FIG. 1 and/or the server 1208 of FIG. 12) according to an embodiment may include a memory 410, a processor 430, and a communication interface 450. The memory 410, the processor 430, and the communication interface 450 may be connected to each other via a communication bus 405.

The memory 410 may store a predicted user-item matrix (e.g., the predicted user-item matrix 107 of FIG. 1, the predicted user-item matrix 220 of FIG. 2, the predicted user-item matrix 520 of FIG. 5, and/or the predicted user-item matrix 830 of FIG. 8) representing the degree of interactions between multiple users and multiple items, predicted by a recommendation model (e.g., the recommendation model (R) 120 of FIG. 1).

The processor 430 may extract a first submatrix (e.g., the first submatrix 117 of FIG. 1 and/or the first submatrix 580 of FIG. 5) from the user-item matrix 107 predicted by the recommendation model (R) 120. The first submatrix 117 may be a model or information to approximate the recommendation model (R) 120 to a dedicated recommendation model (e.g., the dedicated recommendation model (\tilde{R}) 150 of FIG. 1) for a target user. The processor 430 may determine first similar users (e.g., identify first similar users) that are similar to the target user corresponding to an electronic device (e.g., the electronic device 103 of FIG. 1, the electronic device 600 of FIG. 6, and/or the electronic device 1201 of FIG. 12) among multiple users. Here, the “target user corresponding to the electronic device” may include a user who owns the electronic device 103 and/or all users who use a predetermined app through an authentication procedure on the electronic device 103.

The processor 430 may determine the first similar users based on at least one of additional information of the target user and a past item history of the target user, wherein the additional information may include, for example, one or more of information that represents or specifies the user, such as the gender, age, occupation, residence (address), and interest of the user. The processor 430 may determine the first similar users based on a result of comparing similarities between items included in the predicted user-item matrix 107 and items included in the past item history of the target user. The server 400 may compare the similarities between the items included in the predicted user-item matrix 107 and the items included in the past item history of the target user, and determine users corresponding to items with similarity comparison results higher than a predetermined criterion to be the first similar users.

The processor 430 may determine the first similar users based on a result of comparing similarities between users included in the predicted user-item matrix 107 and the additional information of the target user. For example, if the target user is an adult male in his 30s and is interested in travel and music, the server 400 may determine users with the age of 30s, gender of male, and interest in travel or music, among the users included in the predicted user-item matrix 107, to be the first similar users.

The processor 430 may determine candidate items (e.g., identify candidate items) to be provided to the target user among a plurality of items. The processor 430 may determine the candidate items based on past item histories of the first similar users, recommended items predicted for the first similar users by the recommendation model (R) 120, and items selected from among the multiple items other than the recommended item. The processor 430 may determine recommended items to be provided to the target user by combining, for example, the past item histories of the first similar users, top-k (a natural number satisfying k>0) recommended items among the predicted for the first similar users by the recommendation model (R) 120, and items selected at random from among the multiple items other than the recommended item.

The processor 430 may extract the first submatrix 117 corresponding to the first similar users and the candidate items from the predicted user-item matrix 107.

The communication interface 450 may receive a recommendation request (e.g., the recommendation request 104 of FIG. 1) transmitted from the electronic device 103 and transmit the first submatrix 117 extracted by the processor 430 to the electronic device 103.

The processor 430 may execute a program and control the server 400. Program code to be executed by the processor 430 may be stored in the memory 410.

In addition, the processor 430 may perform at least one method that will be described with reference to FIGS. 4 to 12 below or a scheme corresponding to the at least one method. The server 400 may be a hardware-implemented electronic device having a physically structured circuit to execute operations performed by the processor 430. The operations may include, for example, code or instructions included in a program. The hardware-implemented processor 430 may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and/or a neural processing unit (NPU).

FIG. 5 is a diagram illustrating an operation of a server according to an embodiment. Referring to FIG. 5, a diagram 500 shows the operation of the server 101 (e.g., the server 400 of FIG. 4, and/or the server 1208 of FIG. 12) from a data processing perspective according to an embodiment.

The server 101 may include the recommendation model (R) 120 pre-trained based on past item histories of multiple users and the user-item matrix 520 predicted by the recommendation model (R) 120 (e.g., the predicted user-item matrix 107 of FIG. 1 or the user-item matrix 220 of FIG. 2). The recommendation model (R) 120 may output the user-item matrix 520 representing the degree of interactions between multiple users and multiple items as a prediction result. The recommendation model (R) 120 may be trained based on training data 510 such as an M×N user-item matrix [X] representing the degree of interactions between, for example, M users (User-1, User-2, . . . , User-M) and N items (Item-1, Item-2, . . . , Item-N). For example, if the past user-item history 106 for User x is in the server 101, the training data 510 may include the past user-item history of User x. The user-item matrix [X], which is the training data 510, may have the form of a sparse matrix, for example, as in the user-item matrix (X) 210 of FIG. 2, but is not necessarily limited thereto.

The trained recommendation model (R) 120 may output, as a prediction result, the M×N user-item matrix [X^{pred}] 520 in which the values of elements empty in the user-item matrix [X] are filled by predicting the degree of interactions for users and items. The user-item matrix [X^{pred}] 520 may be a matrix in which all element values are filled, for example, as in the user-item matrix (X^{pred}) 220 of FIG. 2.

The server 101 may store the trained recommendation model (R) 120 and the M×N user-item matrix [X^{pred}] 520 corresponding to the prediction result of the trained recommendation model (R) 120. Additionally, the server 101 may determine the top-K recommended items 108 showing a high degree of interactions with users by the M×N user-item matrix [X^{pred}] 520 and store the top-K recommended items 108 in a database.

For example, the server 101 may receive the recommendation request 104 from the electronic device (e.g., the electronic device 103 of FIG. 1, the electronic device 600 of FIG. 6, and/or the electronic device 1201 of FIG. 12) of User x. At this time, the recommendation request 104 only specifies information about who requested a recommendation (e.g., identification information of User x) and does not include any personal information of the user related to items, such as specific item history of the user, thereby preventing personal information from leaking.

When the server 101 receives the recommendation request 104, the primary model extraction block 110 may extract the first submatrix 580 (e.g., the first submatrix 117 of FIG. 1) from the user-item matrix [X^{pred}] 520 predicted by the recommendation model (R) 120.

The similar user extraction module 111 of the primary model extraction block 110 may extract, for example, M₁(M₁<<M) similar users who are similar to User x who transmitted the recommendation request 104 from among the M users included in the M×N user-item matrix [X^{pred}] 520 predicted by the recommendation model (R) 120. The similar user extraction module 111 may extract the similar users using user the additional information 105 (e.g., the gender, age, address, interest, hobby, and marriage) of User x already in the server 101.

The similar user extraction module 111 may extract M₁ users having user information similar to the additional information of User x who transmitted the recommendation request 104 from among the M users included in the M×N user-item matrix [X^{pred}] 520 predicted by the recommendation model (R) 120. For example, if the target user (User x) is an adult male in his 30s and is interested in sports, games, and stocks, the similar user extraction module 111 may determine users (e.g., User-1) who are adult males in their 30s and are interested in sports, games, and stocks, among the M users included in the user-item matrix [X^{pred}] 520, to be the first similar users.

Alternatively, if the past user-item history 106 of User x is in the server 101, the similar user extraction module 111 may compare the similarity between the past user-item history 106 of User x and the matrix [X] used to train the recommendation model (R) 120, i.e., the item histories of users. The similar user extraction module 111 may determine, for example, users corresponding to items with the highest similarities to the items included in the past user-item history 106 among the N items included in the user-item matrix [X^{pred}] 520 or users corresponding to item histories with higher similarities than a predetermined criterion to the items included in the past user-item history 106 among the N items included in the user-item matrix [X^{pred}] 520, to be the first similar users.

For example, the items included in the past user-item history 106 of User x may be Item-2, . . . , and Item-N, and the items corresponding to User-3 among the N items included in the user-item matrix [X^{pred}] 520 may be Item-1, Item-2, . . . , and Item-N and thus, have highest similarities. In this case, the similar user extraction module 111 may determine User-3 to be a first similar user.

In addition, the candidate item extraction module 113 may select N₁(N₁<<N) candidate items to be provided to User x who requested a recommendation from among the N items included in the user-item matrix [X^{pred}] 520 predicted by the recommendation model (R) 120. The candidate item extraction module 113 may select, for example, as candidate items, all items 570 selected at random from past item histories 560 of the first similar users 550 (e.g., User-1 and/or User-3) extracted by the similar user extraction module 111, top-K recommended items 565 predicted by the recommendation model (R) 120 for the first similar users 550, and the remaining items excluding the top-K recommended items 565 predicted by the recommendation model (R) 120 for the first similar users 550 from the N items included in the user-item matrix [X^{pred}] 520. At this time, the top-K recommended items 565 predicted by the recommendation model (R) 120 for the similar users 550 may be the values corresponding to User-1 and User-3 being the first similar users, fetched from a memory or database, among Top-K recommended item 108 for each user determined using the user-item matrix [X^{pred}] 520 predicted by the recommendation model (R) 120.

The items 570 may be, for example, some items selected at random from among the remaining items excluding the top-K recommended items 565 from the N items included in the user-item matrix [X^{pred}] 520.

The first submatrix extraction module 115 may extract the M₁×N₁ (here, M₁<<M and N₁<<N) first submatrix ([X_{x,1}^{pred}]) 580 corresponding to M₁ similar users (e.g., User-1 and User-3) selected by the similar user extraction module 111 and N₁ candidate items extracted by the candidate item extraction module 113, from the M×N user-item matrix [X^{pred}] 520 predicted by the recommendation model (R) 120. The server 101 may transmit the first submatrix ([X_{x,1}^{pred}]) 580 to the electronic device 103 of User x.

FIG. 6 is a block diagram of an electronic device according to an embodiment. Referring to FIG. 6, the electronic device 600 (e.g., the electronic device 103 of FIG. 1 and/or the electronic device 1201 of FIG. 12) according to an embodiment may include a communication interface 610, a processor 630, and a memory 650. The communication interface 610, the processor 630, and the memory 650 may be connected to each other via a communication bus 605.

The communication interface 610 may transmit a recommendation request (e.g., the recommendation request 104 of FIG. 1) to a server (e.g., the server 101 of FIG. 1, the server 400 of FIG. 4, and/or the server 1208 of FIG. 12). The communication interface 610 may receive a first submatrix (e.g., the first submatrix 117 of FIG. 1 and/or the first submatrix 580 of FIG. 5) for approximating a recommendation model (e.g., the recommendation model (R) 120 of FIG. 1) stored in the server 101 to a dedicated recommendation model (e.g., the dedicated recommendation model (\tilde{R}) 150 of FIG. 1) for a target user of the electronic device 600, transmitted by the server 101 in response to the recommendation request 104.

The processor 630 may generate a second submatrix (e.g., the second submatrix 730 of FIG. 7) corresponding to second similar users extracted from the first submatrix 580 based on an item history of the target user at the time of transmitting the recommendation request 104. The processor 630 may extract the second similar users from the first submatrix 580 and extract the second submatrix 730 corresponding to the second similar users from the first submatrix 580. The processor 630 may extract the second similar users among the first similar users based on, for example, similarities between the item history of the target user at the time of transmitting the recommendation request 104 and candidate items included in the first submatrix 580. At this time, the candidate items included in the first submatrix 580 may be items corresponding to the first similar users. The processor 630 may extract the second submatrix 730 corresponding to the second similar users from the first submatrix 580.

The processor 630 may provide recommended items to the target user using a dedicated recommendation model (e.g., the dedicated recommendation model (\tilde{R}) 150 of FIG. 1) trained based on the second submatrix 730. The processor 630 may provide the target user with recommended items corresponding to the time of transmitting the recommendation request 104 and an explanation corresponding to the recommended items using the trained dedicated recommendation model (\tilde{R}) 150. The dedicated recommendation model (\tilde{R}) 150 may be trained based on, for example, weights based on the similarity between the item history of the target user at the time of transmitting the recommendation request 104 and an item history included in the second submatrix 730.

The memory 650 may store the trained dedicated recommendation model (\tilde{R}) 150.

The processor 630 may execute a program and control the electronic device 600. Program code to be executed by the processor 630 may be stored in the memory 650.

In addition, the processor 630 may perform at least one method that is described with reference to FIGS. 1 to 12 or a scheme corresponding to the at least one method. The electronic device 600 may be a hardware-implemented electronic device having a physically structured circuit to execute operations by the processor 630. The operations may include, for example, code or instructions included in a program. The hardware-implemented processor 630 may include, for example, a microprocessor, a CPU, a GPU, a processor core, a multi-core processor, a multiprocessor, an ASIC, an FPGA, and/or an NPU.

FIG. 7 is a diagram illustrating an operation of an electronic device according to an embodiment. Referring to FIG. 7, a diagram 700 shows the operation of an electronic device (e.g., the electronic device 103 of FIG. 1, the electronic device 600 of FIG. 6, and/or the electronic device 1201 of FIG. 12) from a data processing perspective according to an embodiment.

The electronic device 103 may generate an M₂×N₁ (here, M₂<M₁) second submatrix ([X_{x,2}^{pred}]) 730 by reprocessing the M₁×N₁ (here, M₁<<M and N₁<<N) first submatrix ([X_{x,1}^{pred}]) 580 (e.g., the first submatrix 117 of FIG. 1), transmitted from a server (e.g., the server 101 of FIG. 1, the server 400 of FIG. 1, and/or the server 1208 of FIG. 12), through the secondary model extraction block 130.

The secondary model extraction block 130 may extract M₂ second similar users from the first submatrix ([X_{x,1}^{pred}]) 580 based on the specific item history information 135 (e.g., Item-2, . . . , and Item-N 710) at the current time of the user, that is, the time of a recommendation request (e.g., the recommendation request 104 of FIG. 1), and extract the M₂×N₁ second submatrix ([X_{x,2}^{pred}]) 730 corresponding to the second similar users.

The similar user extraction module 131 of the secondary model extraction block 130 may extract the second similar users from the M₁×N₁ (here, M₁<<M and N₁<<N) first submatrix ([X_{x,1}^{pred}]) 580 based on the item history 710 (e.g., Item-2, . . . , and Item-N) of User x at the time of transmitting the recommendation request 104.

The similar user extraction module 131 may calculate vector similarities between the item history 135 of User x at the time of transmitting the recommendation request 104 and candidate items included in the first submatrix ([X_{x,1}^{pred}]) 580. The vector similarities may be obtained based on, for example, angle-based cosine similarity, Jaccard similarity, and/or distance-based Euclidean distance, but are not necessarily limited thereto.

The similar user extraction module 131 may compare, for example, the similarities (“vector similarities) between the vectors of Item-2, . . . , and Item-N 710 and the vector values corresponding to items included in the first submatrix ([X_{x,1}^{pred}]) 580.

The similar user extraction module 131 may extract the second submatrix ([X_{x,2}^{pred}]) 730 corresponding to the second similar users (e.g., User-3) from the first submatrix ([X_{x,1}^{pred}]) 580. At this time, the second submatrix ([X_{x,2}^{pred}]) 730 may have, for example, a size of M₂×N₁. The second submatrix ([X_{x,2}^{pred}]) 730 may include the same number of items as that of the first submatrix ([X_{x,1}^{pred}]) 580 and a reduced number of users.

In an embodiment, the number of items included in the second submatrix ([X_{x,2}^{pred}]) 730 may be maintained as N₁ which is the same as that of the first submatrix ([X_{x,1}^{pred}]) 580 to keep the diversity of recommended items, and the number of users included in the second submatrix ([X_{x,2}^{pred}]) 730 may be reduced to M₂ to reduce the processing load of the electronic device 103. At this time, the M₂ users may be users who have the most similar item histories to User x, such as User-3, for example. The dedicated recommendation model 150 may be trained to recommend the most appropriate recommendation result for User x, i.e., the items most likely to be preferred by User x, based on recommended items corresponding to the M₂ users.

The similar user extraction module 131 may determine similarity rankings of the first similar users with respect to the target user (User x) based on the vector similarity between the item histories. The similar user extraction module 131 may determine some users (e.g., User-3) with high similarity rankings among the first similar users to be the second similar users.

The similar user extraction module 131 may determine the similarity rankings of the first similar users based on the similarity comparison result. Here, the “similarity rankings” may be sequential rankings of the degree to which the first similar users are similar to User x by the similarity between the item vectors. The “similar rankings” may also be called “similar scores”.

The similar user extraction module 131 may determine some (e.g., User-3) of the first similar users included in the first submatrix ([X_{x,1}^{pred}]) 580 to be the second similar users close to User x, for example, in the order of high similarity rankings.

The second submatrix extraction module 135 may extract the second submatrix ([X_{x,2}^{pred}]) 730 corresponding to the second similar users (e.g., User-3) from the first submatrix ([X_{x,1}^{pred}]) 580. For example, if the first submatrix ([X_{x,1}^{pred}]) 580 is an M₁×N₁ matrix, the second submatrix ([X_{x,2}^{pred}]) 730 may be an M₂×N₁ matrix. At this time, M₂<M₁ may be satisfied.

The dedicated recommendation model (\tilde{R}) 150 may be trained based on the second submatrix ([X_{x,2}^{pred}]) 730. The electronic device 103 may train, in operation 140, the dedicated recommendation model (\tilde{R}) 150 based on the second submatrix ([X_{x,2}^{pred}]) 730 extracted by the secondary model extraction block 130, thereby training, in operation 140, the dedicated recommendation model (\tilde{R}) 150 to recommend a recommendation result most similar to User x, that is, the items most likely to be preferred by User x.

The dedicated recommendation model (\tilde{R}) 150 may be expressed as, for example, (Predicted score vector for item)=(Item history vector)*Weight (W). The “item history vector” may denote a vector representing the history of items purchased by User x. The item history vector may be displayed, for example, as “1” for items corresponding to the item history at the time of the recommendation request 104, and “0” for the remaining item(s). The item history vector may be, for example, in the form of a 1×N₁ vector (here, N₁ is the number of items satisfying N₁<<N). The weight (W) may be a parameter of the dedicated recommendation model (\tilde{R}) 150, determined by training in operation 140. The weight (W) may be, for example, an N₁×N₁ matrix, but is not necessarily limited thereto. The weight (W) may be calculated using well-known learning schemes in the field of machine learning, such as, but not necessarily limited to, the error back-propagation scheme and the least squares scheme. The “predicted score vector” for an item may represent the result of predicting the degree of interest of a user in each item. The predicted score vector may have the form, for example, of (Item history vector)×Weight (W)=1×N₁ vector, but is not necessarily limited thereto.

The dedicated recommendation model (\tilde{R}) 150 may be trained, in operation 140, to output recommended items for User x along with an explanation of the reason for recommending the recommended items, when the item history information at the current time (the time of the recommendation request 104) is input.

The electronic device 103 may provide recommended items and explanation 160 corresponding to the recommendation result to the target user using the trained dedicated recommendation model (\tilde{R}) 150. The recommended items and explanation 160 corresponding to the recommendation result by the dedicated recommendation model (\tilde{R}) 150 may be provided in the form of such as, for example, an interpretation 840 of the recommendation result of FIG. 8 below, but is not limited thereto.

FIG. 8 is a diagram illustrating an explainable recommendation model according to an embodiment. Referring to FIG. 8, a drawing 800 shows an item similarity matrix (W) 820 representing calculated vector similarities and an interpretation 840 of recommendation results corresponding to the vector similarities according to an embodiment.

An electronic device (e.g., the electronic device 103 of FIG. 1, the electronic device 600 of FIG. 6, and/or the electronic device 1201 of FIG. 12) according to an embodiment may obtain a predicted user-item matrix (X^{pred}) 830 (e.g., the predicted user-item matrix 107 of FIG. 1, the predicted user-item matrix 220 of FIG. 2, and/or the predicted user-item matrix 520 of FIG. 5) based on a dot product between an item history (e.g., the user-item matrix (X) 810) of User x at the time of transmitting a recommendation request (e.g., the recommendation request 104 of FIG. 1) and the item similarity matrix (W) 820.

The item similarity matrix (W) 820 may be determined by training, in operation 140, described with reference to FIG. 7, as, for example, a parameter of the dedicated recommendation model (\tilde{R}) 150. The weight (W) obtained as a result of training may be conceptually interpreted as a “similarity between items.” The similarity between items may be obtained as, for example, (Score of User-1 for Item-3)=(Similarity between Item-1 viewed by User-1 and target item, Item-3)+(Similarity between Item-2 viewed by User-1 and target item, Item-3)+ . . . . The item similarity matrix (W) 820 may be obtained by various machine learning schemes such as, for example, error back-propagation and least squares.

The electronic device 103 may obtain the elements of the user-item matrix (X^{pred}) 830 as follows, for example. The vector values of items corresponding to USER-1 in the user-item matrix (X) 810 may be [1, 1, 0, 0, . . . ]. Additionally, the similarity values between Item-3 and the other items in the item similarity matrix (W) 820 may be [0.5, 0.3, 0, . . . ]. The electronic device 103 may predict the value of Item-3 corresponding to USER-1 in the user-item matrix (X^{pred}) 830 based on the dot products [1×0.5+1×0.3+0+ . . . ] between the vector values [1, 1, 0, 0, . . . ] of the items corresponding to USER-1 in the user-item matrix 810 and the similarity values [0.5, 0.3, 0, . . . ] between Item-3 and the other items in the item similarity matrix (W) 820.

The electronic device 103 may predict the values of the elements of the user-item matrix (X^{pred}) 830 in the same manner as described above. At this time, since the vector value of Item-3 corresponding to USER-1 in the user-item matrix (X^{pred}) 830 is obtained based on the dot products [1×0.5+1×0.3+0+ . . . ]) described above, the electronic device 103 may provide the interpretation 840 of the recommendation result (e.g., Item-3) saying, for example, “The score of User-1 for Item-3 is 0.8 because User-1 consumed in the past Item-1 having similarity of 0.5 to Item-3 and Item-2 having similarity of 0.3 to Item-3.” when Item-3 is determined as a recommended item corresponding to USER-1.

In an embodiment, providing recommended items for the target user together with an explanation (interpretation) on the recommendation of the recommended items by inputting the item history information of the target user into the trained dedicated recommendation model (e.g., the dedicated recommendation model (\tilde{R}) 150 of FIG. 1) may allow the user to reasonably understand the reason for the recommendation of the recommended items.

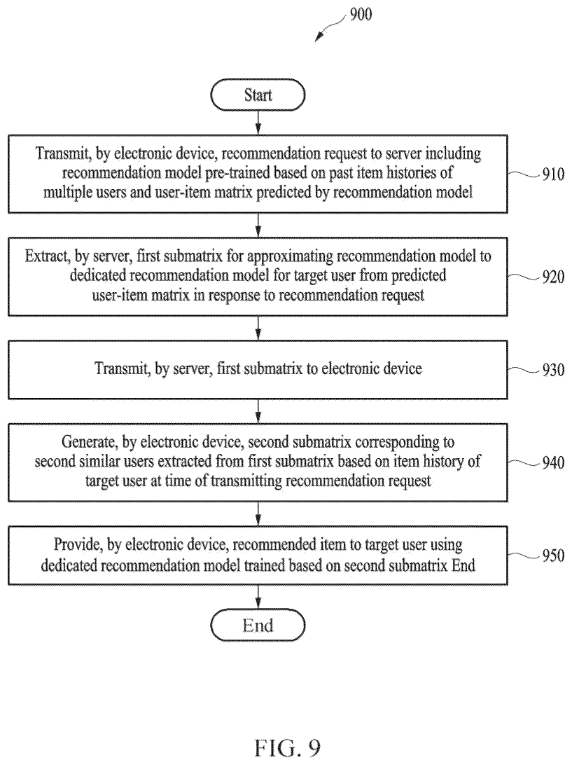

FIG. 9 is a flowchart illustrating a method of operating a recommendation system according to an embodiment. In the following embodiment, operations may be performed sequentially, but are not necessarily performed sequentially. For example, the operations may be performed in different orders, and at least two of the operations may be performed in parallel.

A recommendation system (e.g., the recommendation system 100 of FIG. 1) may include a server (e.g., the server 101 of FIG. 1, the server 400 of FIG. 4, and/or the server 1208 of FIG. 12) and an electronic device (e.g., the electronic device 103 of FIG. 1, the electronic device 600 of FIG. 6, and/or the electronic device 1201 of FIG. 12), and may provide a recommended item to a target user through operations 910 to 950.

In operation 910, the electronic device 103 may transmit a recommendation request (e.g., the recommendation request 104 of FIG. 1) to the server 101. The server 101 may include a recommendation model (R) (e.g., the recommendation model 120 of FIG. 1) pre-trained based on past item histories of multiple users and a user-item matrix predicted by the recommendation model (R) 120 (e.g., the predicted user-item matrix 107 of FIG. 1, the predicted user-item matrix 220 of FIG. 2, the predicted user-item matrix 520 of FIG. 5, and/or the predicted user-item matrix 830 of FIG. 8).

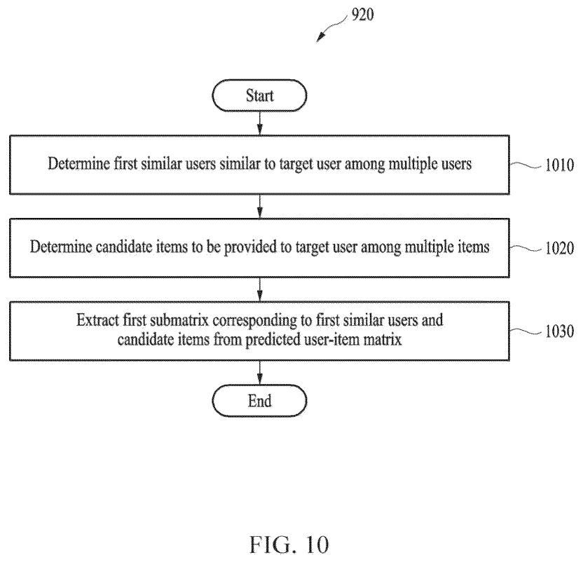

In operation 920, the server 101 may extract a first submatrix (e.g., the first submatrix 117 of FIG. 1 and/or the first submatrix 580 of FIG. 5) for approximating the recommendation model (R) 120 to a dedicated recommendation model (e.g., the dedicated recommendation model (\tilde{R}) 150 of FIG. 1) for a target user from the user-item matrix 830 predicted in response to the recommendation request 104 received in operation 910. The method of extracting the first submatrix 580 by the server 101 is described in more detail with reference to FIG. 10 below.

In operation 930, the server 101 may transmit the first submatrix 580 extracted in operation 920 to the electronic device 103.

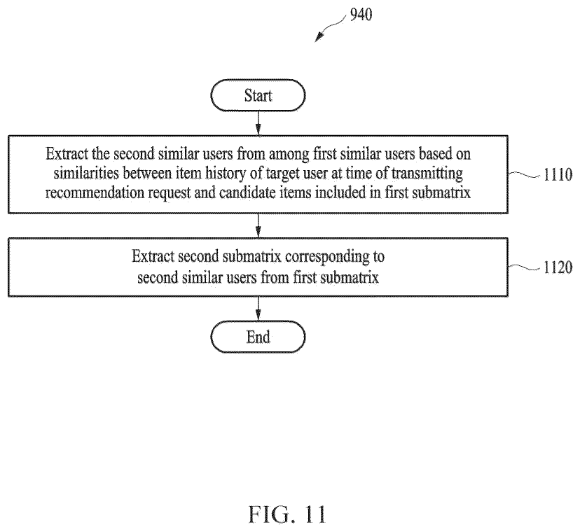

In operation 940, the electronic device 103 may generate a second submatrix (e.g., the second submatrix 730 of FIG. 7) corresponding to second similar users extracted from the first submatrix 580 received in operation 930, based on an item history of the target user at the time of transmitting the recommendation request 104. The method of generating the second submatrix 730 by the electronic device 103 is described in more detail with reference to FIG. 11 below.

In operation 950, the electronic device 103 may provide a recommended item to the target user using the dedicated recommendation model (\tilde{R}) 150 trained based on the second submatrix 730.

FIG. 10 is a flowchart illustrating a method of extracting a first submatrix according to an embodiment. In the following embodiment, operations may be performed sequentially, but are not necessarily performed sequentially. For example, the operations may be performed in different orders, and at least two of the operations may be performed in parallel.

A server (e.g., the server 101 of FIG. 1, the server 400 of FIG. 4, and/or the server 1208 of FIG. 12) of a recommendation system (e.g., the recommendation system 100 of FIG. 1) may extract a first submatrix through operations 1010 to 1030.

In operation 1010, the server 101 may determine first similar users similar to the target user among the multiple users. The server 101 may determine the first similar users based on at least one of additional information of the target user and a past item history of the target user, wherein the additional information includes one or more of the gender, age, occupation, residence (address), and interest of the user. The server 101 may determine the first similar users based on a result of comparing similarities between items included in the predicted user-item matrix (e.g., the predicted user-item matrix 107 of FIG. 1, the predicted user-item matrix 220 of FIG. 2, the predicted user-item matrix 520 of FIG. 5, and/or the predicted user-item matrix 830 of FIG. 8) and items included in the past item history of the target user. The server 101 may compare the similarities between the items included in the predicted user-item matrix 520 and the items included in the past item history of the target user, and determine users corresponding to items with similarity comparison results higher than a predetermined criterion to be the first similar users. Alternatively, the server 101 may determine the first similar users based on a result of comparing similarities between users included in the predicted user-item matrix 520 and the additional information of the target user. For example, if the target user is an adult male in his 30s and is interested in travel and music, the server 101 may determine users with the age of 30s, gender of male, and interest in travel or music, among the users included in the predicted user-item matrix 520, to be the first similar users.

In operation 1020, the server 101 may determine candidate items to be provided to the target user among a plurality of items. The server 101 may determine, for example, the candidate items based on past item histories of the first similar users determined in operation 1010, recommended items predicted for the first similar users by the recommendation model (R) (e.g., the recommendation model (R) 120 of FIG. 1), and items selected from among the multiple items other than the recommended item. The server 101 may determine recommended items to be provided to the target user by combining, for example, the past item histories of the first similar users, top-k (a natural number satisfying k>0) recommended items among the predicted for the first similar users by the recommendation model (R) 120, and items selected at random from among the multiple items other than the recommended item.

In operation 1030, the server 101 may extract the first submatrix (e.g., the first submatrix 117 of FIG. 1 and/or the first submatrix 580 of FIG. 5) corresponding to the first similar users determined in operation 1010 and the candidate items determined in operation 1020, from the predicted user-item matrix 520.

FIG. 11 is a flowchart illustrating a method of extracting a second submatrix according to an embodiment. In the following embodiment, operations may be performed sequentially, but are not necessarily performed sequentially. For example, the operations may be performed in different orders, and at least two of the operations may be performed in parallel.

An electronic device (e.g., the electronic device 103 of FIG. 1, the electronic device 600 of FIG. 6, and/or the electronic device 1201 of FIG. 12) of a recommendation system (e.g., the recommendation system 100 of FIG. 1) may extract a second submatrix (e.g., the second submatrix 730 of FIG. 7) through operations 1110 and 1120.

In operation 1110, the electronic device 103 may extract the second similar users from among the first similar users based on similarities between the item history of the target user at the time of transmitting a recommendation request (e.g., the recommendation request 104 of FIG. 1) in operation 910 of FIG. 9 described above and the candidate items included in a first submatrix (e.g., the first submatrix 117 of FIG. 1 and/or the first submatrix 580 of FIG. 5) extracted in operation 920.

In operation 1120, the electronic device 103 may extract the second submatrix 730 corresponding to the second similar users extracted in operation 1110 from the first submatrix 580 transmitted in operation 930 of FIG. 9 described above.

FIG. 12 is a block diagram of an electronic device 1201 in a network environment according to an embodiment. Referring to FIG. 12, an electronic device 1201 (e.g., the electronic device 103 of FIG. 1 and/or the electronic device 600 of FIG. 6) in a network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, the memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In some embodiments, at least one of the components (e.g., the connecting terminal 1278) may be omitted from the electronic device 1201, or one or more other components may be added to the electronic device 1201. In some embodiments, some of the components (e.g., the sensor module 1276, the camera module 1280, or the antenna module 1297) may be integrated as a single component (e.g., the display module 1260).

The processor 1220 may execute, for example, software (e.g., a program 1240 to control at least one other component (e.g., a hardware or software component) of the electronic device 1201 coupled with the processor 1220, and may perform various data processing or computation. According to an embodiment, as at least part of data processing or computation, the processor 1220 may store a command or data received from another component (e.g., the sensor module 1276 or the communication module 1290) in a volatile memory 1232, process the command or the data stored in the volatile memory 1232, and store resulting data in a non-volatile memory 1234. According to an embodiment, the processor 1220 may include the main processor 1221 (e.g., a CPU or an application processor (AP)), or an auxiliary processor 1223 (e.g., a GPU, an NPU, an ISP, a sensor hub processor, or a CP) that is operable independently from, or in conjunction with the main processor 1221. For example, when the electronic device 1201 includes the main processor 1221 and the auxiliary processor 1223, the auxiliary processor 1223 may be adapted to consume less power than the main processor 1221 or to be specific to a specified function. The auxiliary processor 1223 may be implemented separately from the main processor 1221 or as part of the main processor 1221.

The auxiliary processor 1223 may control at least some of functions or states related to at least one (e.g., the display module 1260, the sensor module 1276, or the communication module 1290 of the components of the electronic device 1201, instead of the main processor 1221 while the main processor 1221 is in an inactive (e.g., sleep) state, or together with the main processor 1221 while the main processor 1221 is an active state (e.g., executing an application). According to an embodiment, the auxiliary processor 1223 (e.g., an ISP or a CP) may be implemented as a portion of another component (e.g., the camera module 1280 or the communication module 1290) that is functionally related to the auxiliary processor 1223. According to an embodiment, the auxiliary processor 1223 (e.g., an NPU) may include a hardware structure specified for processing of an artificial intelligence (AI) model. An artificial intelligence model may be generated through machine learning. Such learning may be performed, e.g., by the electronic device 1201 where the artificial intelligence is performed, or via a separate server (e.g., the server 1208. Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network, or a combination of two or more thereof, but is not limited thereto. The artificial intelligence model may, additionally or alternatively, include a software structure other than the hardware structure.

The memory 1230 may store various data used by at least one component (e.g., the processor 1220 or the sensor module 1276 of the electronic device 1201. The various data may include, for example, software (e.g., the program 1240 and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220 of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for playing multimedia or playing a record. The receiver may be used to receive an incoming call. According to an embodiment, the receiver may be implemented separately from the speaker or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250 or output the sound via the sound output module 1255 or an external electronic device (e.g., the electronic device 1202 such as a speaker or a headphone) directly or wirelessly connected with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202 directly (e.g., wiredly) or wirelessly. According to an embodiment, the interface 1277 may include, for example, a high-definition multimedia interface (HDMI), a universal serial bus (USB) interface, a secure digital (SD) card interface, or an audio interface.

The connecting terminal 1278 may include a connector via which the electronic device 1201 may be physically connected with an external electronic device (e.g., the electronic device 1202. According to an embodiment, the connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or an electrical stimulus which may be recognized by a user via his or her tactile sensation or kinesthetic sensation. According to an embodiment, the haptic module 1279 may include, for example, a motor, a piezoelectric element, or an electric stimulator.

The camera module 1280 may capture a still image and moving images. According to an embodiment, the camera module 1280 may include one or more lenses, image sensors, ISPs, or flashes.

The power management module 1288 may manage power supplied to the electronic device 1201. According to an embodiment, the power management module 1288 may be implemented as, for example, at least part of a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208 and performing communication via the established communication channel. The communication module 1290 may include one or more communication processors that operate independently of the processor 1220 (e.g., an application processor) and support direct (e.g., wired) communication or wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module, or a power line communication (PLC) module). A corresponding one of these communication modules may communicate with the external electronic device 1204 via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the SIM 1296.

The wireless communication module 1292 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., a mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), an array antenna, analog beamforming, or a large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element including a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 from the plurality of antennas. The signal or the power may be transmitted or received between the communication module 1290 and the external electronic device via the at least one selected antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the external electronic devices 1202 and 1204 may be a device of a same type as, or a different type from, the electronic device 1201. According to an embodiment, all or some of operations to be executed by the electronic device 1201 may be executed at one or more external electronic devices (e.g., the external devices 1202 and 1204, and the server 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In an embodiment, the external electronic device 1204 may include an Internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The electronic device according to the embodiments disclosed herein may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software (e.g., the program 1240) including one or more instructions that are stored in a storage medium (e.g., internal memory 1236 or external memory 1238) that is readable by a machine (e.g., the electronic device 1201 of FIG. 12). For example, a processor (e.g., the processor 1220) of the machine (e.g., the electronic device 1201) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two electronic devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

According to an embodiment, a recommendation system 100 may include a server 101, 400, or 1208 including a recommendation model 120 pre-trained based on past item histories 106 of multiple users and a user-item matrix 107, 220, 520, or 830 predicted by the recommendation model 120, the server configured to, based on receiving a recommendation request 104, extract a first submatrix 117 or 580 for approximating the recommendation model 120 to a dedicated recommendation model 150 for a target user from the predicted user-item matrix 107, 220, 520, or 830 and transmit the first submatrix, and an electronic device 103, 600, or 1201 configured to transmit the recommendation request 104, and provide the target user with a recommended item using the dedicated recommendation model 150 trained based on a second submatrix 730 generated by reprocessing the first submatrix 117 or 580 based on an item history of the target user at a time of transmitting the recommendation request 104.

According to an embodiment, the server 101, 400, or 1208 may include a memory 410 configured to store the recommendation model 120 and the predicted user-item matrix 107, 220, 520, or 830 representing a degree of interactions between the multiple users and multiple items predicted by the recommendation model 120, a processor 430 configured to extract the first submatrix 117 or 580 from the predicted user-item matrix 107, 220, 520, or 830, and a communication interface 450 configured to receive the recommendation request 104 and transmit the first submatrix 117 or 580 to the electronic device 103, 600, or 1201.

According to an embodiment, the processor 430 may be configured to determine first similar users similar to the target user corresponding to the electronic device 103, 600, or 1201 among the multiple users, determine candidate items to be provided to the target user among the multiple items, and extract the first submatrix 117 or 580 corresponding to the first similar users and the candidate items from the predicted user-item matrix 107, 220, 520, or 830.

According to an embodiment, the processor 430 may be configured to determine the first similar users based on at least one of additional information 105 of the target user and a past item history 106 of the target user, wherein the additional information may include one or more of a gender, an age, an occupation, a residence, and an interest of a user.

According to an embodiment, the processor 430 may be configured to determine the first similar users based on a result of comparing similarities between items included in the predicted user-item matrix 107, 220, 520, or 830 and items included in the past item history 106 of the target user.

According to an embodiment, the processor 430 may be configured to determine the first similar users based on a result of comparing similarities between users included in the predicted user-item matrix 107, 220, 520, or 830 and the additional information 105 of the target user.

According to an embodiment, the processor 430 may be configured to determine the candidate items based on past item histories 106 of the first similar users, recommended items predicted for the first similar users by the recommendation model 120, and items selected from among the multiple items other than the recommended item.

According to an embodiment, the electronic device 103, 600, or 1201 may include a communication interface 610 configured to transmit the recommendation request 104 to the server 101, 400, or 1208 and receive the first submatrix 117 or 580 from the server 101, 400, or 1208 in response to the recommendation request 104, a processor 630 configured to extract second similar users from the first submatrix 117 or 580 based on an item history of the target user at a time of transmitting the recommendation request 104, extract the second submatrix 730 corresponding to the second similar users from the first submatrix 117 or 580, and provide the target user with a recommended item using the dedicated recommendation model 150 trained based on the second submatrix 730, and a memory 650 configured to store the dedicated recommendation model 150.

According to an embodiment, an electronic device 103, 600, or 1201 may include a communication interface 610 configured to transmit a recommendation request 104 to a server 101, 400, or 1208 and receive a first submatrix 117 or 580 for approximating a recommendation model 120 stored in the server 101, 400, or 1208 to a dedicated recommendation model 150 for a target user of the electronic device 103, 600, or 1201 from the server 101, 400, or 1208 in response to the recommendation request 104, a processor 630 configured to generate a second submatrix 730 corresponding to second similar users extracted from the first submatrix 117 or 580 based on an item history of the target user at a time of transmitting the recommendation request 104, and provide the target user with a recommended item using the dedicated recommendation model 150 trained based on the second submatrix 730, and a memory 650 configured to store the trained dedicated recommendation model 150.

According to an embodiment, the processor 630 may be configured to extract the second similar users from among the first similar users based on similarities between the item history of the target user at the time of transmitting the recommendation request 104 and candidate items included in the first submatrix 117 or 580.

According to an embodiment, the processor 630 may be configured to extract a second submatrix 730 corresponding to the second similar users from the first submatrix 117 or 580.

According to an embodiment, the processor 630 may be configured to provide the target user with a recommended item corresponding to the time of transmitting the recommendation request 104 and an explanation corresponding to the recommended items using the trained dedicated recommendation model 150.

According to an embodiment, the dedicated recommendation model 150 may be trained by a machine learning technique based on the second submatrix 730.

According to an embodiment, a method of operating a recommendation system 100 including a server 101, 400, or 1208 and an electronic device 103, 600, or 1201 may include operation 910 of transmitting, by the electronic device 103, 600, or 1201, a recommendation request 104 to the server 101, 400, or 1208 including a recommendation model 120 pre-trained based on past item histories 106 of multiple users and a user-item matrix 107, 220, 520, or 830 predicted by the recommendation model 120, operation 920 of extracting, by the server 101, 400, or 1208, a first submatrix 117 or 580 for approximating the recommendation model 120 to a dedicated recommendation model 150 for a target user from the predicted user-item matrix 107, 220, 520, or 830 in response to the recommendation request 104, operation 930 of transmitting, by the server 101, 400, or 1208, the first submatrix 117 or 580 to the electronic device 103, 600, or 1201, operation 940 of generating, by the electronic device 103, 600, or 1201, a second submatrix 730 corresponding to second similar users extracted from the first submatrix 117 or 580 based on an item history of the target user at a time of transmitting the recommendation request 104, and operation 950 of providing, by the electronic device 103, 600, or 1201, a recommended item to the target user using the dedicated recommendation model 150 trained based on the second submatrix 730.

According to an embodiment, the extracting of the first submatrix 117 or 580 may include determining first similar users similar to the target user among the multiple users; determining candidate items to be provided to the target user among the multiple items, and extracting the first submatrix 117 or 580 corresponding to the first similar users and the candidate items from the predicted user-item matrix 107, 220, 520, or 830.

According to an embodiment, the determining of the first similar users may include determining the first similar users based on at least one of additional information 105 of the target user and a past item history 106 of the target user, wherein the additional information may include one or more of a gender, an age, and an interest of a user.

According to an embodiment, the determining of the first similar users may include at least one of determining the first similar users based on a result of comparing similarities between items included in the predicted user-item matrix 107, 220, 520, or 830 and items included in the past item history 106 of the target user, and determining the first similar users based on a result of comparing similarities between users included in the predicted user-item matrix 107, 220, 520, or 830 and the additional information 105 of the target user.

According to an embodiment, the determining of the candidate items may include determining the candidate items based on past item histories 106 of the first similar users, recommended items predicted for the first similar users by the recommendation model 120, and items selected from among the multiple items other than the recommended item.

According to an embodiment, the generating of the second submatrix 730 may include extracting the second similar users from among the first similar users based on similarities between the item history of the target user at the time of transmitting the recommendation request 104 and candidate items included in the first submatrix 117 or 580, and extracting the second submatrix 730 corresponding to the second similar users from the first submatrix 117 or 580.

What is claimed is:

1. A recommendation system comprising:
a server comprising:
a recommendation model pre-trained based on past item histories of multiple users; and
a user-item matrix predicted by the recommendation model,
wherein the server is configured to, based on receiving a recommendation request, extract a first submatrix for approximating the recommendation model to a dedicated recommendation model for a target user from the predicted user-item matrix and transmit the first submatrix; and
an electronic device configured to:
transmit the recommendation request; and
provide the target user with a recommended item using the dedicated recommendation model trained based on a second submatrix generated by reprocessing the first submatrix based on an item history of the target user at a time of transmitting the recommendation request.

2. The recommendation system of claim 1, wherein the server comprises:
a memory configured to store the recommendation model and the predicted user-item matrix representing a degree of interactions between the multiple users and multiple items predicted by the recommendation model;
a processor configured to extract the first submatrix from the predicted user-item matrix; and
a communication interface configured to receive the recommendation request and transmit the first submatrix to the electronic device.

3. The recommendation system of claim 2, wherein the processor is configured to:
identify first similar users similar to the target user corresponding to the electronic device among the multiple users;
identify candidate items to be provided to the target user among the multiple items; and
extract the first submatrix corresponding to the first similar users and the candidate items from the predicted user-item matrix.

4. The recommendation system of claim 3, wherein the processor is configured to identify the first similar users based on at least one of additional information of the target user or a past item history of the target user, wherein the additional information of the target user comprises one or more of a gender, an age, an occupation, a residence, or an interest of a user.

5. The recommendation system of claim 4, wherein the processor is configured to identify the first similar users based on a result of comparing similarities between items included in the predicted user-item matrix and items included in the past item history of the target user.

6. The recommendation system of claim 4, wherein the processor is configured to identify the first similar users based on a result of comparing similarities between users included in the predicted user-item matrix and the additional information of the target user.

7. The recommendation system of claim 3, wherein the processor is configured to identify the candidate items based on past item histories of the first similar users, recommended items predicted for the first similar users by the recommendation model, and items selected from among the multiple items other than the recommended item.

8. The recommendation system of claim 1, wherein the electronic device comprises:
a communication interface configured to transmit the recommendation request to the server and receive the first submatrix from the server in response to the recommendation request;
a processor configured to extract second similar users from the first submatrix based on an item history of the target user at the time of transmitting the recommendation request, extract the second submatrix corresponding to the second similar users from the first submatrix, and provide the target user with a recommended item using the dedicated recommendation model trained based on the second submatrix; and
a memory configured to store the dedicated recommendation model.

9. An electronic device comprising:
a communication interface configured to transmit a recommendation request to a server and receive a first submatrix for approximating a recommendation model stored in the server to a dedicated recommendation model for a target user of the electronic device from the server in response to the recommendation request;
a processor configured to generate a second submatrix corresponding to second similar users extracted from the first submatrix based on an item history of the target user at a time of transmitting the recommendation request, and provide the target user with a recommended item using the dedicated recommendation model trained based on the second submatrix; and
a memory configured to store the trained dedicated recommendation model.

10. The electronic device of claim 9, wherein the processor is configured to extract the second similar users from among first similar users based on similarities between the item history of the target user at the time of transmitting the recommendation request and candidate items included in the first submatrix.

11. The electronic device of claim 10, wherein the processor is configured to extract the second submatrix corresponding to the second similar users from the first submatrix.

12. The electronic device of claim 9, wherein the processor is configured to provide the target user with a recommended item corresponding to the time of transmitting the recommendation request and an explanation corresponding to recommended items using the trained dedicated recommendation model.

13. The electronic device of claim 9, wherein the dedicated recommendation model is trained by a machine learning technique based on the second submatrix.

14. A method of operating a recommendation system comprising a server and an electronic device, the method comprising:
transmitting, by the electronic device, a recommendation request to the server comprising a recommendation model pre-trained based on past item histories of multiple users and a user-item matrix predicted by the recommendation model;
extracting, by the server, a first submatrix for approximating the recommendation model to a dedicated recommendation model for a target user from the predicted user-item matrix in response to the recommendation request;
transmitting, by the server, the first submatrix to the electronic device;
generating, by the electronic device, a second submatrix corresponding to second similar users extracted from the first submatrix based on an item history of the target user at a time of transmitting the recommendation request; and
providing, by the electronic device, a recommended item to the target user using the dedicated recommendation model trained based on the second submatrix.

15. The method of claim 14, wherein the extracting of the first submatrix comprises:
identifying first similar users similar to the target user among the multiple users;
identifying candidate items to be provided to the target user among multiple items; and
extracting the first submatrix corresponding to the first similar users and the candidate items from the predicted user-item matrix,
wherein the identifying of the first similar users comprises identifying the first similar users based on at least one of additional information of the target user or a past item history of the target user, wherein the additional information comprises one or more of a gender, an age, or an interest of a user.
